(19) United States
(12) Patent Application Publication
(10) Pub. No.: US 2006/0019526 A1
(43) Pub. Date: Jan. 26, 2006

(54) Connector for mobile communication device

(75) Inventor: Hyung-Woo Jeon, Gyeonggi-Do (KR)

Correspondence Address: JONATHAN Y. KANG, ESQ.;LEE,HONG, DEGERMAN, KANG & SCHMADEKA, 14th Floor, 801 S. Flgueroa Street, Los Angeles, CA, 90017, US

(73) Assignee: LG Electronics Inc.

(21) Appl. No.: 11/187,298

(22) Filed: Jul. 21, 2005

(30) Foreign Application Priority Data
Jul. 21, 2004 (KR) 56926/2004

(51) Int. Cl. H01R 13/627

(52) U.S. Cl. 439/358

(57) ABSTRACT

A connector for connecting to a mobile terminal is provided. The connector comprises an actuator for engaging first and second elongated locking levers longitudinally positioned inside the housing in a front to back direction and extend along the internal surfaces of the first and second sides of the housing respectively. Each of the first and second levers protrude through at least a first opening in the front of the housing to lock the connector in a receptacle of the mobile communication terminal.

### CROSS-REFERENCE TO RELATED APPLICATIONS

Pursuant to 35 U.S.C. § 119(a), this application claims the benefit of earlier filing date and right of priority to Korean Patent Application No. 56926/2004, filed on Jul. 21, 2004, the content of which is hereby incorporated by reference herein in its entirety.

### FIELD OF THE INVENTION

The present invention relates to a connector for a mobile communication terminal, and particularly to a single button connector that can be easily separated from a receptacle of a mobile communication terminal.

### BACKGROUND OF THE INVENTION

Communication terminals such as mobile phones and PDAs have a data port or electrical socket (i.e., receptacle) for connecting with external devices such as computers, power sources and other accessories. This receptacle is configured to electrically receive a plug connector and cable. FIG. 1 illustrates a related art receptacle 13 and plug connector 21.

Typically, a receptacle 13 is provided in a bottom portion of a communication terminal 10 so as to be connected with a plug connector 21 of an external device, like a charger. A plurality of connection pins 14 for electrically connecting the plug connector 21 and an inner circuit of the terminal are provided inside the receptacle 13.

The plug connector 21 includes a plug body 23 having an insertion unit 25 (e.g., a male coupling) at one end, the insertion unit 25 being inserted into the receptacle 13 for electrically coupling to the connection pins 14.

Referring to FIG. 2, a locking lever 31 is flexibly installed in the plug body 23 and is elastically manipulatable according to application of external pressure. The locking lever 31 is installed to extend along both sides of the insertion unit 25 for maintaining a lock state when the plug connector 21 is inserted in the receptacle 13. Push buttons 35 are integrally formed with the locking lever 31 to be pressed at both sides of the plug body 23, for unlocking the plug connector 21, by releasing the locking lever 31.

A plurality of connection terminals (not shown) are provided inside the insertion unit 25 to contact the connection pins 14 of the receptacle 13. A space 27 is formed at each edge of both sides of the insertion unit 25. As a result, one side of the locking lever 31 is elastically manipulated in response to external pressure.

Furthermore, an electric or data cord 28 is connected to the connection terminals at one side of the plug body 23. A hook 33 is formed at an end portion of each locking lever 31, so as to engage a stopping groove 15.

When desiring to connect the plug connector 21 with the receptacle 13, the insertion unit 25 of the plug body 23 is inserted into the receptacle 13. Each hook 33 elastically connects with an inner edge of the receptacle 13 and is inserted therein. When the receptacle 13 is fully inserted, the hook engages a stopping groove 15 formed in the receptacle 13 so as to removably couple the plug connector 21 to the receptacle.

When desiring to separate the plug connector 21 from the receptacle 13, push buttons 35 are pressed. The push buttons 35 protrude from the plug body 23. A problem associated with the related art is that both push buttons 35 have to be simultaneously pressed in order to unlock the hooks 33. Each hook 33 is separated from the stopping groove 15 to move into spaces 27 formed at both side surfaces of the insertion unit 25. Accordingly, the insertion unit 25 may be removed by pressing both actuators 35 while pulling at the plug connector 21 at the same time.

Unfortunately, when a user does not press both actuators 35 with the same force or simultaneously, one or more of the hooks of locking lever 31 may not fully release from stopping grooves 15. As a result, the plug connector 21 is not smoothly separated from the receptacle 13. Thus, physical damage may occur in the hooks 33 and the stopping grooves 15. This can cause serious problems with reliability and durability of the mobile terminal 10.

As such, a solution to the above problem is needed.

### SUMMARY OF THE INVENTION

Features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a connector for connecting to a port of a mobile communication terminal comprising a housing having top, bottom, front, rear and first and second sides.

First and second elongated locking levers are longitudinally positioned inside the housing in a front to back direction and extend along the internal surfaces of the first and second sides of the housing respectively. Each of the first and second levers protrudes through at least a first opening in the front of the housing.

The front of the housing is configured to support a male coupling enclosed therein for mating with a female receptacle of a mobile communication terminal. The rear of the housing is configured to receive a cable electrically connected to the male coupling. The top of the housing provides a second opening to receive an actuator.

In accordance with one aspect of the invention, the actuator comprises a raised cap portion protruding upwardly through the second opening, and first and second wedges connected to the cap, the wedges extending downward toward the bottom of the housing to engage the first and second levers respectively, such that pressing on the actuator causes the first and second wedges to move downwardly and contact the first and second levers respectively in first and second regions.

The first and second regions face first and second internal sidewalls of the housing respectively. The first region comprises a first raised nipple and the second region comprises a second raised nipple. The first and second nipples respectively correspond to the first and second wedges, such that when the actuator is pressed, a terminal end of the first wedge contacts the first nipple and a terminal end of the second wedge contacts the second nipple.

In one embodiment, the first and second wedges respectively engage the first and second nipples. Downward force exerted on the actuator is transferred to the first and second nipples in a lateral direction by way of the first and second wedges respectively, thereby moving the first and second levers toward center of the housing.

The first and second levers respectively comprise first and second hook mechanisms at terminal end portions of the levers that protrude through the first opening. The hook mechanisms respectively engage first and second matching grooves in the receptacle to firmly couple the male coupling into the receptacle's opening.

In accordance with one embodiment, first and second levers have a biasing property such that when the first and second wedges respectively contact the first and second regions, the first and second levers bend toward each other. When pressure on the actuator is removed, the first and second levers responsively deflect away from each other.

When the pressure on the actuator is removed, the responsive deflection of the first and second levers away from each other pushes back the actuator in an upward direction by way of the first and second wedges. In a preferred embodiment, the first and second wedges contact the first and second regions almost simultaneously.

When pressure is applied on the actuator the downward force is transferred to laterally move the first and second hooks toward each other to thereby disengage the first and second hooks from the respective first and second grooves in an unlock state. When pressure is removed from the actuator, the deflection of the first and second levers away from each other engages the first and second hooks to first and second grooves respectively, in a lock state.

In a preferred embodiment, the actuator comprising the cap and the first and second wedges has a monolithic construction. In another preferred embodiment, the housing further comprises a first step disposed along the internal surface of the first side of the housing; and a second step disposed along the internal surface of the second side of the housing, wherein in an unlock state the first wedge is placed between the first nipple and the first step, and the second wedge is placed between the second nipple and the second step.

These and other embodiments of the present invention will also become readily apparent to those skilled in the art from the following detailed description of the embodiments having reference to the attached figures, the invention not being limited to any particular embodiments disclosed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a perspective view illustrating receptacle and plug connector for a communication terminal according to related art.

FIG. 2 illustrates an inner structure of the plug connector for the communication terminal according to related art.

FIG. 3 is a perspective view illustrating receptacle and plug connector for a communication terminal according to an embodiment of the present invention,

FIG. 4 illustrates an inner structure of a plug connector for a communication terminal according to an embodiment of the present invention.

FIG. 5 is an enlarged perspective view of the locking mechanism of the invention in accordance with one embodiment.

FIG. 6 is a cross-sectional view taken along the line VI-VI in FIG. 4.

FIG. 7 is an operational view of a plug connector according to an embodiment of the present invention.

FIG. 8 is an enlarged view illustrating the release and locking mechanism of another embodiment of the present invention.

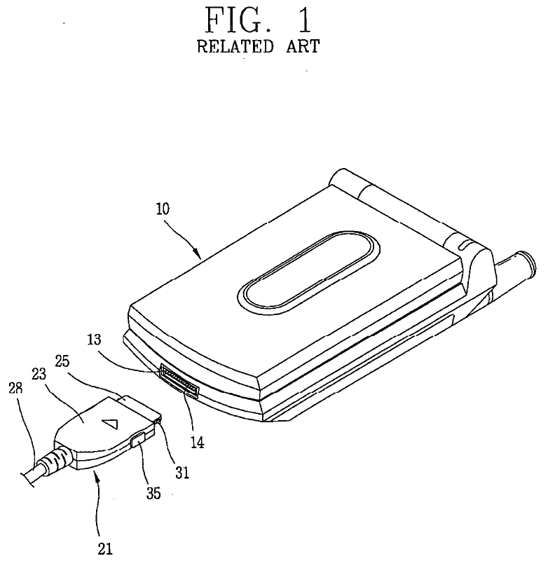

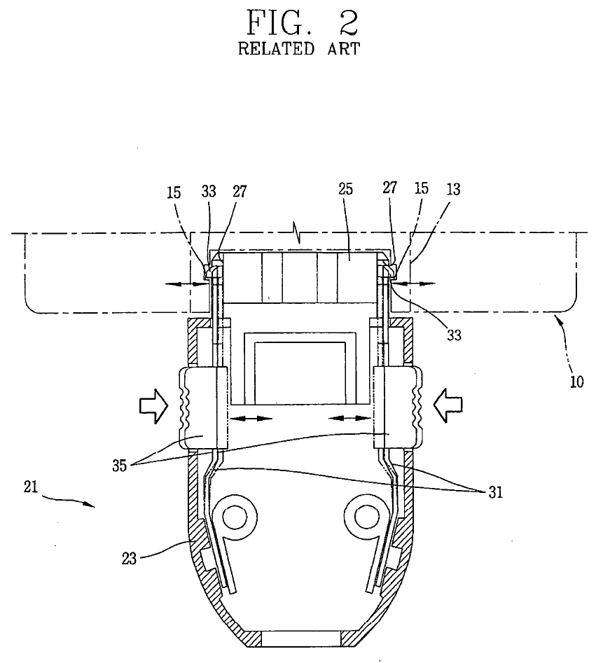

Features, elements, and aspects of the invention that are referenced by the same numerals in different figures represent the same, equivalent, or similar features, elements, or aspects in accordance with one or more embodiments of the system. Reference will now be made in detail to the preferred embodiments of the present invention, examples of which are illustrated in the accompanying drawings.

### DETAILED DESCRIPTION OF THE PREFERRED EMBODIMENTS

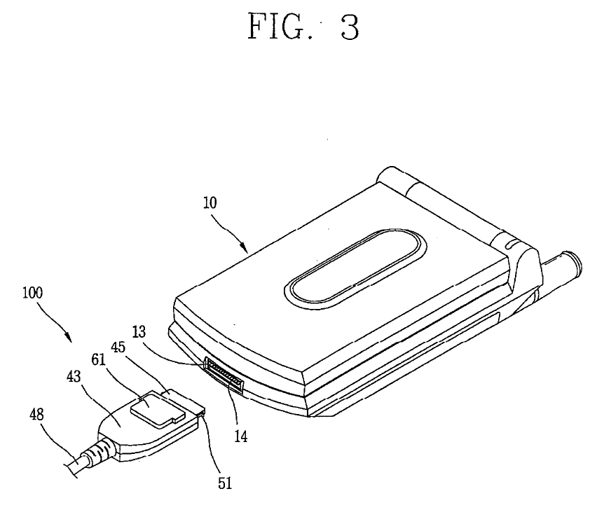

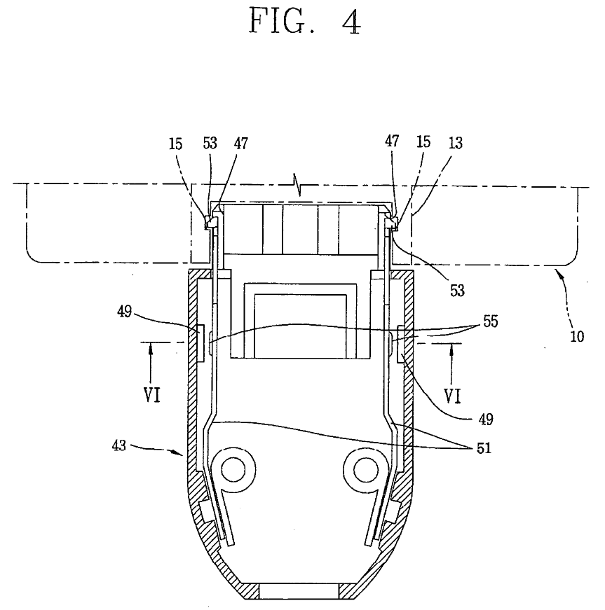

Referring to FIGS. 3 and 4, a plug connector 100 for a mobile communication terminal 10 (e.g., a cellular phone, PDA, etc.) according to an embodiment of the present invention comprises a housing 43 having male coupling (i.e., an insertion unit) 45 for insertion into a receptacle 13 of the communication terminal 10. A locking mechanism is installed inside the housing 43 to lock the male coupling 45 in place when the male coupling 45 is plugged into the receptacle 14.

In a preferred embodiment, the housing 43 comprises one or more elongated levers 51 (hereafter, first and second levers 51 by way of example) that extend along the internal opposite side surfaces of the housing 43 and protrude from an opening in the front portion of the housing 43 along the direction of protrusion of the male coupling 45 from the housing.

As shown in FIG. 4, the first and second levers 51 are inserted in the receptacle 13 along with the male coupling 45 to engage the plug connector 100 to the receptacle 13 in a locked state, and to disengage the plug connector 100 from the receptacle 14 in an unlock state, as provided in further detail below.

First and second levers 51 each have a fixed end connected inside the housing 43 and an opposite distal terminal end that extends along the internal side surface of the housing 43 to protrude outwardly from the opening in front of the housing 43. The male coupling 45 is disposed in between the first and second levers 51. First and second hooks 53 are respectively formed at first and second end portions of first and second levers 51.

Preferably, first and second hooks 53 are configured to respectively engage first and second grooves 15 positioned at inner lateral surfaces of the receptacle 13. The first and second levers 51 have biasing characteristics that allows the first and second levers 51 to flex when external force is applied to a mid-region thereof. The first and second levers 51 are preferably made of an elastic material such as memory wire made of stainless steel, rubber or plastic, for example.

In one embodiment, biasing members such as leaf springs are used to maintain the biasing force associated with the first and second levers 51. The first and second hooks 53 engage (e.g., latch onto) the first and second grooves 15 of the receptacle 13 in a locked position and disengage from the first and second grooves 15 in an unlocked position, as shown in FIG. 4.

Referring to FIG. 3, the connector housing 100 comprises an actuator 61 partially protruding from a first opening defined on the top portion of the housing 43. Referring to FIG. 6, in accordance with one embodiment, actuator 61 comprises a cap having a plurality of wedges (hereafter first and second wedges by way of example) 63 extending therefrom in a downward direction.

In a preferred embodiment, the actuator 61 is a push button or pressure sensitive mechanical apparatus in which pressure applied to a top portion of the apparatus is directly transferred to the first and second wedges 61 connected thereto in a downward direction with respect to the housing 43. The cap and the wedges 61 may have a monolithic construction in an exemplary embodiment.

In accordance with one aspect of the invention, when pressure is applied to the actuator 61, the downward force is directly applied to a region of each first and second levers 51 by way of the first and second wedges 63, respectively. In a preferred embodiment, first and second respective regions of the first and second levers 51 may comprise first and second nipples 55, wherein the first nipple corresponds to the first wedge and the second nipple corresponds to the second wedge, so that when pressure is applied to the actuator 61, the first and second wedges 63 engage the first and second nipples 55, respectively.

Referring to FIGS. 3, 4 and 6, the actuator 61 is disposed in the housing 43 through an opening 44 defined, for example, on the top surface of the housing 43. In a preferred embodiment, the first and second nipples 55 are respectively formed or disposed on a mid-section of the first and second levers 51, opposite first and second steps 49. A nipple 55 can be formed by way of, for example, pressing or punching to create a depression in one side and a protrusion on the other side of a lever 51.

In accordance with one aspect of the invention, first and second steps 49 are respectively formed or positioned at the inner side surfaces of the housing 43 a certain distance from the first and second nipples 55. The first and second steps 49 are configured to respectively guide the first and second wedges 63, in a lock or unlock state, as further provided below.

In an exemplary embodiment, when pressure is applied to actuator 61 to unlock the connector housing 100 from the receptacle 14, the terminal ends of the first and second wedges 63 are lodged in between the first nipple and the first step, and the second nipple and the second step, respectively. In this state (i.e., unlock state) the downward force is transferred in a lateral direction as a result of the first and second wedges 63 engaging the first and second nipples 55, respectively. The lateral force applied to the first and second nipples 55 pressures the first and second levers 51 to move toward each other (i.e., toward the center of the housing 43 and away from the housing's 43 sidewalls).

Referring to FIG. 6, the distance “d” between the first step and the respective first nipple is set preferably narrower than the thickness “D” of the first wedge. Same proportional measurements are applicable to second nipple and second wedge. In one embodiment, due to the biasing characteristic of the first and second levers 51, when pressure from the actuator 61 is removed, a counter-pressure from the first and second levers 51 is applied against the first and second wedges 63 to drive the actuator 61 upward to its original position.

In one embodiment, the first and second nipples 55 have a curved design to gradually increase the application of pressure between the first and second nipples 55 and the respective first and second wedges 63. In accordance with another embodiment, the terminal ends of the first and second wedges 63 are preferably tapered so that the terminal ends of the first and second wedges 63 form a relatively sharp point.

Accordingly, when the male coupling 45 of the plug connector 100 is inserted into the receptacle 13, the first and second hooks 53 respectively formed at the terminal ends of the first and second levers 51 engage inner sidewalls of the receptacle 13. When the first and second hooks 53 are completely inserted, each hook 53 is engaged with a respective groove 15 formed at an inner side of the receptacle 13 due to the biasing force of each lever 51, in accordance with one aspect of the invention.

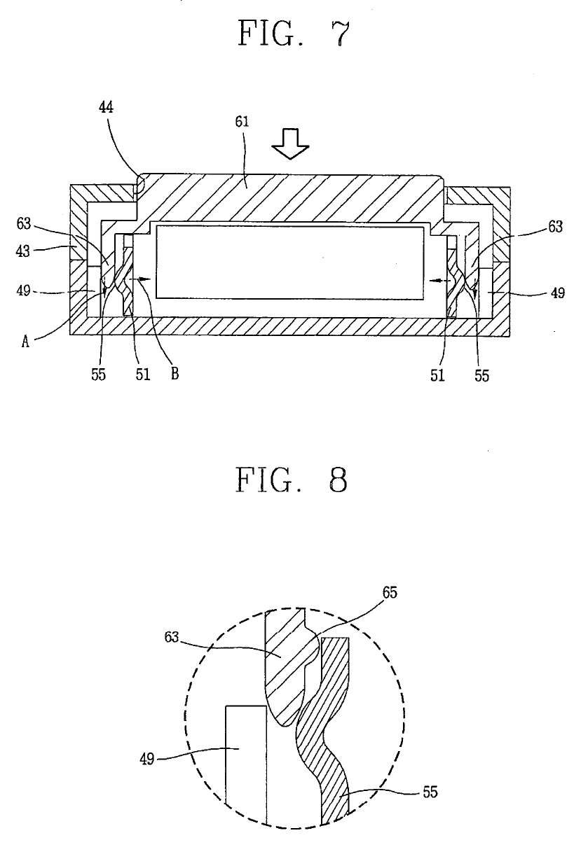

In a preferred embodiment, when the plug connector 100 is to be separated from the receptacle 13, a user can press the actuator 61. When the actuator 61 is pressed, the first and second wedges 63 move along the first and second steps 49, as shown in FIGS. 7 and 8. As a result, each of the first and second nipples 55 engages the respective first and second wedges 63.

In a preferred embodiment, nipple 55 on each lever 51 is simultaneously engaged when pressure is applied to actuator 61. Advantageously, this simultaneous engagement allows for easy and uninterrupted removal of the plug connector 100 from receptacle 14.

The first and second levers 51 move inwardly due to said simultaneous engagement between the nipples 55 and wedges 63. As a result, first and second hooks 53 are released from the grooves 15 of the receptacle 13 and move into the spaces 47 defined at both lateral surfaces of the male coupling 45 (see FIG. 4).

The plug connector 100 may be drawn out to separate the male coupling 45 from the receptacle 13. After drawing the plug connector 100 out, if no force is applied to the actuator 61, both levers 51 and the actuator 61 return back to their original positions by the restoring biasing force of levers 51.

Referring to FIG. 8, in one embodiment, a protrusion 65 is formed at the lateral surface of a wedge 63, and is configured to engage a nipple 55 on a lever 51. Thus, when a user presses the actuator 61, the nipple 55 engages protrusion 65, thereby generating a ‘click’ sound, which the user can hear.

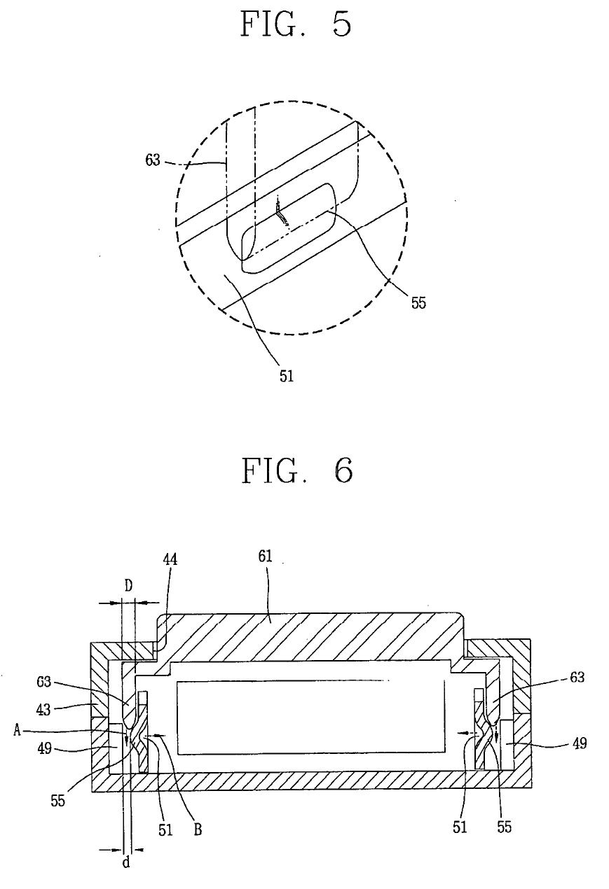

In the exemplary embodiments illustrated in FIGS. 3 through 8, preferred embodiments of a plug connector 100 for a mobile communication terminal are provided. According to one preferred embodiment, one actuator 61 may be used so that the user can easily press the actuator 61 with one finger to simultaneously apply uniform force to levers 51, thereby disengaging the plug connector 100 from the mobile terminal's receptacle 14.

The embodiments described above are to be considered in all aspects as illustrative only and not restrictive in any manner. Thus, other exemplary embodiments, system architectures, platforms and implementations that can support various aspects of the invention may be utilized without departing from the essential characteristics described herein. These and various other adaptations and combinations of features of the embodiments disclosed are within the scope of the invention. The invention is defined by the claims and their full scope of equivalents.

What is claimed is:

1. A connector for connecting to a female receptacle of a mobile terminal, the connector comprising:
a housing; and
first and second elongated locking levers longitudinally positioned inside the housing in a front to back direction and extending along the internal surfaces of a first and second sides of the housing respectively, each of the first and second levers protruding through at least a first opening in the front of the housing, wherein:
a front of the housing is configured to support a male coupling enclosed therein configured for mating with the female receptacle of the mobile terminal,
a top of the housing defining a second opening configured to receive an actuator, the actuator comprising:
a raised cap portion protruding upwardly through the second opening, and
first and second wedges connected to the cap, the wedges extending downwardly toward a bottom of the housing to engage the first and second levers respectively, such that pressing on the actuator causes the first and second wedges to move downwardly and contact the first and second levers respectively in first and second regions.

2. The connector of claim 1, wherein the first and second regions face first and second internal side walls of the housing respectively, the first region comprising a first raised nipple and the second region comprises a second raised nipple, the first and second nipples respectively corresponding to the first and second wedges, such that when the actuator is pressed, a distal terminal end of the first wedge contacts the first nipple and a distal terminal end of the second wedge contacts the second nipple.

3. The connector of claim 2, wherein when the first and second wedges respectively engage the first and second nipples, downward force exerted on the actuator is transferred to the first and second nipples in a lateral direction by way of the first and second wedges respectively, thereby moving the first and second levers toward center of the housing.

4. The connector of claim 3, wherein the first and second levers respectively comprise first and second hooks at terminal ends of the first and second levers.

5. The connector of claim 4, wherein the first and second hooks respectively engage first and second grooves in the receptacle to firmly couple the male coupling into the receptacle's opening.

6. The connector of claim 1, wherein the first and second levers have a biasing property such that when the first and second wedges respectively contact the first and second regions due to application of pressure to the actuator, the first and second levers bend toward each other, and when pressure on the actuator is removed, the first and second levers responsively deflect away from each other.

7. The connector of claim 6, wherein when the pressure on the actuator is removed, the responsive deflection of the first and second levers away from each other pushes back the actuator in an upward direction by way of the first and second wedges.

8. The connector of claim 1, wherein the first and second wedges engage the first and second regions almost simultaneously.

9. The connector of claim 7, wherein when pressure is applied on the actuator, the downward force is transferred to laterally move the first and second hooks toward each other to thereby disengage the first and second hooks from the respective first and second grooves, in an unlock state.

10. The connector of claim 7, wherein when pressure is removed from the actuator, the deflection of the first and second levers away from each other engages the first and second hooks to first and second grooves respectively, in a lock state.

11. The connector of claim 1, wherein the actuator comprising the cap and the first and second wedges has a monolithic construction.

12. The connector of claim 2, wherein the housing further comprises:
a first step disposed along the internal surface of a first side of the housing; and
a second step disposed along the internal surface of a second side of the housing, wherein in an unlock state:
the first wedge is lodged between a first space defined between the first nipple and the first step, and
the second wedge is lodged between a second space defined between the second nipple and the second step.

13. The connector of claim 12, wherein in a lock state:
the first wedge is dislodged from a first space defined between the first nipple and the first step, and
the second wedge is dislodged from a second space defined between the second nipple and the second step.

14. The connector of claim 13, wherein the first and second nipples are located opposite the first and second steps, respectively.

15. The connector of claim 14, wherein the first and second nipples respectively correspond to the first and second wedges, such that when the actuator is pressed, a terminal end of the first wedge contacts the first nipple and a terminal end of the second wedge contacts the second nipple.

16. The connector of claim 15, wherein when the first and second wedges respectively engage the first and second nipples, downward force exerted on the actuator is transferred to the first and second nipples in a lateral direction by way of the first and second wedges respectively, thereby moving the first and second levers toward center of the housing.

17. The connector of claim 16, wherein the first and second levers respectively comprise first and second hooks at terminal end portions of the first and second levers that protrude through the first opening and wherein the hooks respectively engage first and second matching grooves in the receptacle to firmly couple the male coupling into the receptacle's opening.

18. The connector of claim 16, wherein the first and second levers have a biasing property such that when pressure is applied on the actuator the first and second wedges respectively contact the first and second nipples, and the first and second levers bend toward each other as a result, and when pressure on the actuator is removed, the first and second levers responsively deflect away from each other.

19. The connector of claim 18, wherein when the pressure on the actuator is removed, the responsive deflection of the first and second levers away from each other pushes back the actuator in an upward direction by way of the first and second wedges.

20. The connector of claim 1, wherein at least one of a communication line and a data line is attached to the rear of the housing to electrically connect to the male coupling.
